(19) United States
(12) Patent Application Publication
(10) Pub. No.: US 2024/0334321 A1
(43) Pub. Date: Oct. 3, 2024

(54) CONTINUOUS COMMUNICATION SERVICE FOR MOBILE NON-TERRESTRIAL NETWORKS

(71) Applicant: Apple Inc., Cupertino, CA (US)

(72) Inventors: Jie CUI, Sunnyvale, CA (US); Yang Tang, Sunnyvale, CA (US); Qiming Li, Beijing (CN); Haitong Sun, Sunnyvale, CA (US); Dawei Zhang, Sunnyvale, CA (US); Chunxuan Ye, San Diego, CA (US)

(73) Assignee: Apple Inc., Cupertino, CA (US)

(21) Appl. No.: 18/588,969

(22) Filed: Feb. 27, 2024

Related U.S. Application Data
(60) Provisional application No. 63/493,968, filed on Apr. 3, 2023.

(51) Int. Cl. H04W 48/20; H04W 48/16; H04W 64/00

(52) U.S. Cl. CPC H04W 48/20; H04W 48/16; H04W 64/00

(57) ABSTRACT

Some aspects of this disclosure relate to apparatuses and methods for apparatuses and methods for providing continuous communication services for a user equipment (UE) connected to a non-terrestrial network (NTN) and/or one or more satellites providing cellular coverage. The UE may receive a list of neighbor cells from a serving cell, which may be a satellite moving relative to the Earth and having a moving coverage area. After receiving the list of neighbor cells, the UE may sort the list to prioritize the neighbor cells. This sorting may be based on a calculated distance between the UE and each of the neighbor cells. The UE may sequentially perform a synchronization and measurement process with each of the neighbor cells or a subset of the neighbor cells based on the prioritization order. The UE may then establish communications with a target cell from the prioritized list to maintain continuity.

### CROSS-REFERENCE TO RELATED APPLICATION

This application claims benefit of U.S. Provisional Patent Application No. 63/493,968, filed on Apr. 3, 2023, which is incorporated herein by reference in its entirety.

### BACKGROUND

### Field

The described aspects generally relate to mechanisms for maintaining continuous communication coverage for a user equipment (UE) connected to a non-terrestrial network (NTN) with moving serving cells.

### Related Art

In some examples, a user equipment (UE) may connect with a wireless communication network via one or more non-terrestrial network (NTN) cells. For example, this NTN cell coverage may be provided by a satellite in space and/or orbiting the Earth. Due to the movement of the satellite and its corresponding serving cell, a UE may experience a discontinuity in service. For example, the UE may no longer be positioned within the serving cell because the satellite has moved. The coverage area has therefore moved as well. In this manner, the UE may experience a loss of connection to the network. Further, it is unclear how the UE should re-connect to the network or which cell should subsequently serve the UE.

### SUMMARY

Some aspects of this disclosure relate to apparatuses and methods for providing continuous communication services for UE connected to a NTN and/or one or more satellites providing cellular coverage. For example, some aspects of this disclosure relate to apparatuses and methods for configuring a UE to receive a list of neighbor cells from a serving cell. The serving cell may be a satellite providing NTN coverage. The satellite may also be moving relative to the Earth and therefore have a moving cell coverage arca or footprint. After receiving the list of neighbor cells, the UE may sort the list to prioritize the one or more neighbor cells. This sorting may be based on a calculated distance between the UE and each of the neighbor cells. The neighbor cells that are closer or that have a lower calculated distance may be prioritized over neighbor cells that are farther away. The UE may sequentially perform a synchronization and measurement process with each of the neighbor cells or a subset of the neighbor cells based on the prioritization order of the list. Based on the results of the synchronization and measurement process, the UE may establish communications with a target cell from the list of neighbor cells. In this manner, the UE may establish a continuity in service with a neighbor cell.

Some aspects of this disclosure relate to a UE. The UE includes a transceiver configured to enable wireless communications. The transceiver receives communications from a serving cell. The serving cell may be a satellite in an NTN. The UE also includes a processor communicatively coupled to the transceiver. The processor can be configured to receive, from the serving cell, a list of one or more neighbor cells with respective positioning information. The processor is further configured to calculate respective distances between the UE and the one or more neighbor cells using the respective positioning information. The processor is further configured to sort the list of the one or more neighbor cells based on the respective distances to generate a prioritized list that orders the one or more neighbor cells based on the respective distances. The processor is further configured to sequentially perform a synchronization and measurement process with the one or more neighbor cells according to an order of the prioritized list. The processor is further configured to establish communications with a target cell from the prioritized list based on the synchronization and measurement process.

In some aspects, the respective positioning information includes position, velocity, or timing information.

In some aspects, to sequentially perform the synchronization and measurement process, the processor is further configured to identify a subset of the one or more neighbor cells based on the order of the prioritized list and a predefined number of neighbor cells. The processor is further configured to perform the synchronization and measurement process for each neighbor cell in the subset.

In some aspects, to sequentially perform the synchronization and measurement process, the processor is further configured to perform Reference Signal Received Power (RSRP), Reference Signal Received Quality (RSRQ), or Signal to Interference & Noise Ratio (SINR) measurements.

In some aspects, the processor is further configured to calculate the respective distances in response to determining that a serving time corresponding to the serving cell is below a threshold.

In some aspects, the processor is further configured to receive a second list from a second serving cell, wherein the second list includes a set of neighbor cells for the second serving. The processor is further configured to determine that a service time corresponding to the second serving cell is above a threshold and sequentially perform a second synchronization and measurement process with the set of neighbor cells according to an order of the second list. The processor is further configured to establish communications with a cell from the set of neighbor cells based on the second synchronization and measurement process.

In some aspects, the processor is further configured to calculate the respective distances in response to a determining that a distance between the UE and the serving cell is above a threshold.

In some aspects, the processor is further configured to receive a second list from a second serving cell, wherein the second list includes a set of neighbor cells for the second serving cell. The processor is further configured to determine that a distance between the UE and the second serving cell is below a threshold and sequentially perform a second synchronization and measurement process with the set of neighbor cells according to an order of the second list. The processor is further configured to establish communications with a cell from the set of neighbor cells based on the second synchronization and measurement process.

In some aspects, the processor is further configured with a cell type priority designation. The processor is further configured to calculate the respective distances in response to determining that the one or more neighbor cells do not match the cell type priority designation.

In some aspects, the processor is further configured with a cell type priority designation. The processor is further configured to receive a second list from a second serving cell, wherein the second list includes a set of neighbor cells for the second serving cell. The processor is further configured to determine that a neighbor cell from the set matches the cell type priority designation. The processor is further configured to perform a second synchronization and measurement process with the neighbor cell and establish communications with the neighbor cell having the matching cell type priority designation.

In some aspects, the cell type priority designation identifies a geostationary orbiting (GSO) satellite, a terrestrial network (TN) cell, or a non-GSO satellite with a fixed earth cell.

Some aspects of this disclosure relate to an apparatus. The apparatus includes a memory and at least one processor coupled to the memory. The at least one processor can be configured to receive, from a serving cell, a designation of a backup cell for the serving cell, wherein the designation of the backup cell corresponds to a specified time. The processor is further configured to designate the backup cell as having a cell priority at the specified time. The processor is further configured to perform a synchronization and measurement process with the backup cell at the specified time and establish communications with the backup cell based on the synchronization and measurement process at the specified time.

In some aspects, to designate the backup cell as having a cell priority, the at least one processor is further configured to designate the backup cell as having a higher priority than a list of one or more neighbor cells received from the serving cell.

In some aspects, the backup cell corresponds to a geostationary orbiting (GSO) satellite or a terrestrial network (TN) base station.

In some aspects, the serving cell corresponds to a non-geostationary orbiting (non-GSO) satellite with an earth moving cell, a GSO satellite, or a non-GSO satellite with a fixed earth cell.

Some aspects of this disclosure relate to a method performed by UE including receiving, at the user equipment (UE) and from a serving cell, a list of one or more neighbor cells with respective positioning information. The method further includes calculating, by the UE, respective distances between the UE and the one or more neighbor cells using the respective positioning information. The method further includes sorting, by the UE, the list of the one or more neighbor cells based on the respective distances to generate a prioritized list that orders the one or more neighbor cells based on the respective distances. The method further includes sequentially performing, by the UE, a synchronization and measurement process with the one or more neighbor cells according to an order of the prioritized list. The method further includes establishing, by the UE, communications with a target cell from the prioritized list based on the synchronization and measurement process.

In some aspects, the respective positioning information includes position, velocity, or timing information.

In some aspects, to sequentially perform the synchronization and measurement process, the method further comprises identifying a subset of the one or more neighbor cells based on the order of the prioritized list and a predefined number of neighbor cells and performing the synchronization and measurement process for each neighbor cell in the subset.

In some aspects, to sequentially perform the synchronization and measurement process, the method further comprises performing Reference Signal Received Power (RSRP), Reference Signal Received Quality (RSRQ), or Signal to Interference & Noise Ratio (SINR) measurements.

In some aspects, calculating the respective distances occurs in response to determining that a serving time corresponding to the serving cell is below a threshold. In some aspects, calculating the respective distances occurs in response to determining that a distance between the UE and the serving cell is above a threshold.

In some aspects, the UE is configured with a cell type priority designation and calculating the respective distances occurs in response to determining that the one or more neighbor cells do not match the cell type priority designation.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example non-terrestrial network (NTN) where a user equipment (UE) experiences a discontinuity of service, according to some aspects of the disclosure.

FIG. 2 illustrates an example non-terrestrial network (NTN) with a candidate NTN serving cell, according to some aspects of the disclosure.

FIG. 3 illustrates an example non-terrestrial network (NTN) with a candidate base station serving cell, according to some aspects of the disclosure.

FIG. 4 illustrates a block diagram of an example system of an electronic device implementing continuous network connectivity, according to some aspects of the disclosure.

FIG. 5 illustrates an example method for a system (for example, a UE) for establishing communications with a target cell, according to some aspects of the disclosure.

FIG. 6A illustrates an example method for a system (for example, a UE) for establishing communications with a target cell based on a service time of a serving cell, according to some aspects of the disclosure.

FIG. 6B illustrates an example method for a system (for example, a UE) for establishing communications with a target cell based on a distance between the UE and a serving cell, according to some aspects of the disclosure.

FIG. 7 illustrates an example method for a system (for example, a UE) for establishing communications with a target cell based on a cell priority designation, according to some aspects of the disclosure.

FIG. 8 illustrates an example method for a system (for example, a UE) for establishing communications with a target cell based on a backup cell designation, according to some aspects of the disclosure.

FIG. 9 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for providing continuous communication services for a UE connected to a NTN and/or one or more satellites providing cellular coverage. For example, some aspects of this disclosure relate to apparatuses and methods for configuring a UE to receive a list of neighbor cells from a serving cell. The serving cell may be a satellite providing NTN coverage. The satellite may also be moving relative to the Earth and therefore have a moving cell coverage area or footprint. After receiving the list of neighbor cells, the UE may sort the list to prioritize the one or more neighbor cells. This sorting may be based on a calculated distance between the UE and each of the neighbor cells. The neighbor cells that are closer or that have a lower calculated distance may be prioritized over neighbor cells that are farther away. The UE may sequentially perform a synchronization and measurement process with each of the neighbor cells or a subset of the neighbor cells based on the prioritization order of the list. Based on the results of the synchronization and measurement process, the UE may establish communications with a target cell from the list of neighbor cells. In this manner, the UE may establish a continuity in service with a neighbor cell.

In some examples, the aspects of this disclosure can be performed by a network and/or a UE that operates according to 5^{th} generation (5G) wireless technology for digital cellular networks as defined by 3rd Generation Partnership Project (3GPP). Additionally, or alternatively, the aspects of this disclosure can be performed by a network and/or a UE that operates according to the Release 15 (Rel-15), Release 16 (Rel-16), Release 17 (Rel-17), Rel-17 new radio (NR), or others. However, the aspects of this disclosure are not limited to these examples, and one or more mechanisms of this disclosure can be implemented by other network(s) and/or UE(s) for implementing continuous NTN service communications.

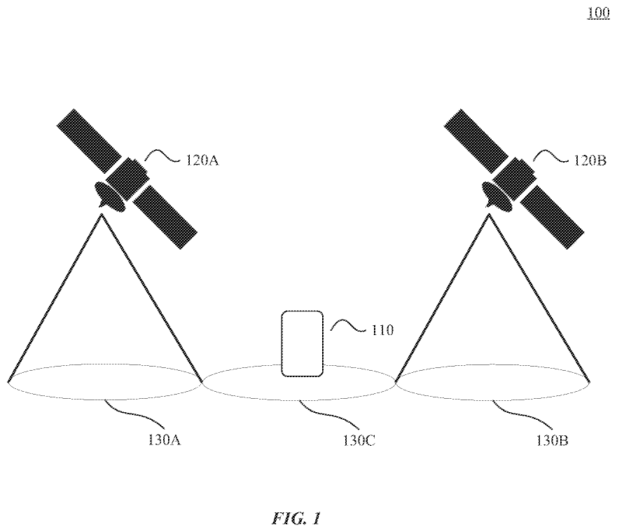

FIG. 1 illustrates an example non-terrestrial network (NTN) 100 where a user equipment (UE) 110 experiences a discontinuity of service, according to some aspects of the disclosure. Example NTN 100 is provided for the purpose of illustration only and does not limit the disclosed aspects.

Non-terrestrial network (NTN) 100 includes UE 110, satellites 120A, 120B, and cells 130A, 130B, 130C. Satellite 120A provides cell 130A while satellite 120B provides cell 130B. Cells 130 may represent coverage areas, footprints, or cellular communication coverage on the Earth. For example, satellite 120A may provide cell 130A and may provide communication coverage for communication devices within cell 130A.

Communication devices within cell 130A communicate with satellite 120A to access a NTN. The NTN access may facilitate communications with other communication devices connected to the NTN. For example, this communication may be performed using 5G protocols.

In some aspects, satellites 120A, 120B are non-geostationary orbiting (non-GSO) satellites. Satellites 120A, 120B may be low Earth orbit (LEO) satellites. In some aspects, satellites 120A, 120B may be medium-earth orbiting (MEO) and/or highly-eccentric orbiting (HEO) satellites. The non-GSO satellites 120A, 120B may be in a constellation or swarm and may facilitate communications with the NTN. In some aspects, satellites 120A, 120B move relative to the Earth. That is, non-GSO satellites 120A, 120B may not be fixed in space relative to the Earth's surface. In view of this movement, their respective cells 130A, 130B also move relative to the Earth. This movement may result in a discontinuity in service for UEs, such as UE 110 which may have been previously positioned within cell 130A or cell 130B.

For example, in a previous instance in time, satellite 120B may have had a communication coverage area covering cell 130C. Satellite 120B may have been serving UE 110 and/or providing UE 110 with a connection to the NTN. Satellite 120B may then move at a subsequent instance in time. This movement may be a movement in space and/or may be a result of satellite 120B being a non-GSO satellite. Due to the movement of satellite 120B, satellite 120B's corresponding coverage area may have moved to cell 130B. UE 110, however, may not have moved. For example, UE 110 may have remained in the previous coverage area corresponding to cell 130C. In this case, UE 110 may no longer have a connection to the NTN because satellite 120B and its corresponding coverage area has moved. UE 110 may experience a discontinuity in service as a result of this movement of satellite 120B.

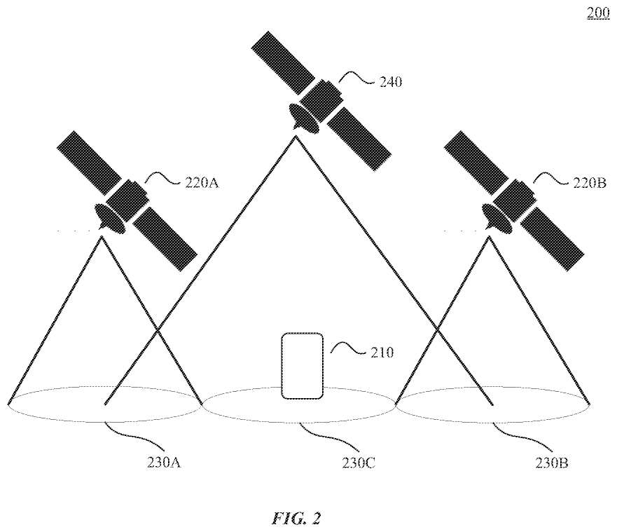

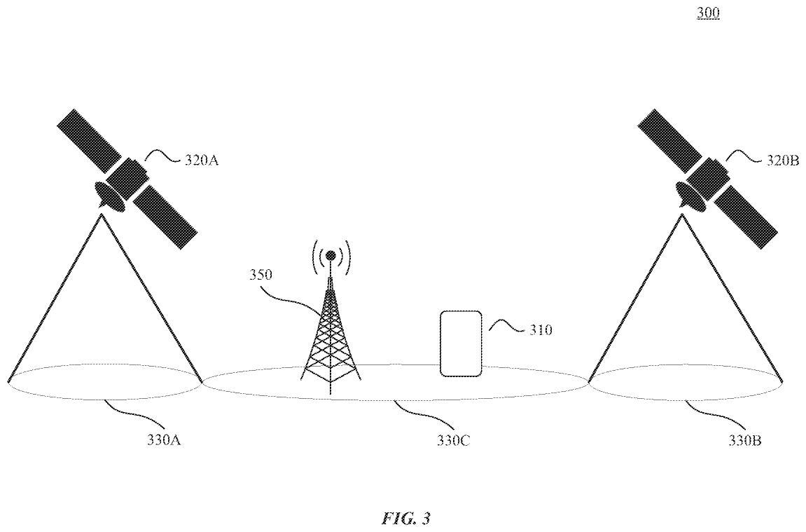

As further discussed in this disclosure, aspects of this disclosure address this discontinuity. Aspects of this disclosure provide apparatuses and methods that provide continuous service to UE 110 even when NTN satellites 120 move and have moving service areas or cells 130. While considering this discontinuity, aspects of this disclosure also address additional NTN scenarios and configurations as depicted in and discussed with reference to FIG. 2 and FIG. 3.

FIG. 2 illustrates an example non-terrestrial network (NTN) 200 with a candidate NTN serving cell, according to some aspects of the disclosure. Example NTN 200 is provided for the purpose of illustration only and does not limit the disclosed aspects.

NTN 200 includes UE 210, satellites 220A, 220B, 240, and cells 230A, 230B, 230C. UE 210 may be similar to UE 110 as described with reference to FIG. 1. Satellites 220A, 220B and cells 230A, 230B may be similar to satellites 120A, 120B and cells 130A, 130B from FIG. 1. For example, satellites 220A, 220B may be non-GSO satellites and/or may move relative to the Earth's surface. This may cause a movement of the coverage area or footprint which may correspond to cells 230A, 230B.

In this configuration, however, another satellite 240 exists and/or may provide coverage for cell 230C. For example, satellite 240 may be a geostationary orbiting (GSO) satellite. This coverage provides a candidate NTN serving cell 230C to maintain coverage for UE 210.

When considering whether to provide NTN service via satellite 240, the system may consider the frequencies and/or carriers used for communications. For example, satellites 220A, 220B may provide communication services using the same frequencies and/or carriers. Satellite 240, however, may provide communication services using different frequencies and/or carriers. The operations described below address this scenario. The operations account for and/or determine whether service by a GSO satellite such as satellite 240 is appropriate to address potential discontinuities. As further discussed below, a GSO satellite may be considered and/or prioritized above or below other non-GSO satellites for providing continuous service.

FIG. 3 illustrates an example non-terrestrial network (NTN) 300 with a candidate base station serving cell, according to some aspects of the disclosure. Example NTN 300 is provided for the purpose of illustration only and does not limit the disclosed aspects.

NTN 300 includes UE 310, satellites 320A, 320B, and cells 330A, 330B, 330C. NTN 300 also includes a base station 350. In some aspects, base station 350 may be a terrestrial network (TN) base station and/or a gNB. Base station 350 may provide coverage for cell 330C. This may provide a candidate TN serving cell 330C to maintain coverage for UE 310. In this manner, UE 310 may connect to base station 350 for a TN connection. UE 310, however, may have multiple options such as base station 350, another non-GSO satellite, or a GSO satellite for access a communication network. The operations described below address this scenario. The operations account for and/or determine whether service by a base station 350 is appropriate to address potential discontinuities. As further discussed below, a base station 350 and/or a TN cell 330C may be considered and/or prioritized above or below satellite connections for providing continuous service.

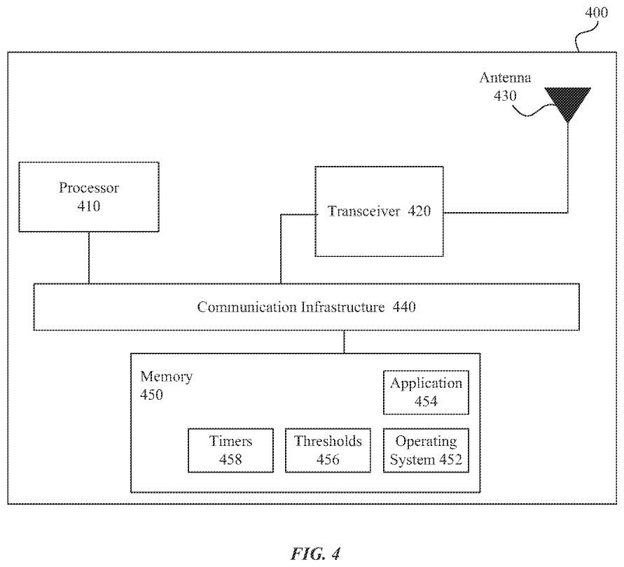

FIG. 4 illustrates a block diagram of an example system 400 of an electronic device implementing continuous network connectivity, according to some aspects of the disclosure. System 400 may be any of, or included in any of, the electronic devices (e.g., UE 110, 210, 310, satellites 120, 220, 240, 320, and/or base station 350) of systems 100, 200, 300. System 400 includes a processor 410, one or more transceivers 420, a communication infrastructure 440, a memory 450, operating system 452, application 454, thresholds 456, timers 458, and/or an antenna 430. Illustrated systems are provided as exemplary parts of system 400, and system 400 can include other circuit(s) and subsystem(s). Also, although the systems of system 400 are illustrated as separate components, the aspects of this disclosure can include any combination of these, less, or more components. Also, system 400 of the aspects of this disclosure can include any number of processors, transceivers, communication infrastructures, memories, operating systems, applications, and antennas.

The memory 450 may include random access memory (RAM) and/or cache, and may include control logic (e.g., computer software) and/or data. The memory 450 may include other storage devices or memory such as, but not limited to, a hard disk drive and/or a removable storage device/unit. According to some examples, the operating system 452 can be stored in memory 450. The operating system 452 can manage transfer of data between the memory 450, one or more applications 454, the processor 410, and/or one or more transceivers 420. In some examples, the operating system 452 maintains one or more network protocol stacks (e.g., Internet protocol stack, cellular protocol stack, and the like) that can include a number of logical layers. At corresponding layers of the protocol stack, the operating system 452 includes control mechanism and data structures to perform the functions associated with that layer.

According to some examples, the application 454 can be stored in the memory 450. The application 454 can include applications (e.g., user applications) used by wireless system 400 and/or a user of wireless system 400. The applications in the application 454 can include applications such as, but not limited to, mobile communications, radio streaming, video streaming, remote control, and/or other user applications.

According to some aspects, the memory 450 can store different thresholds 256. The thresholds 456 can include, but are not limited to, service time thresholds for serving cell timing, distance thresholds for distances between system 400 and a serving cell, DL channel quality threshold, UL channel quality threshold, or the like. The memory 450 can store timers 458. The timers 458 can include timers and/or counters discussed herein. For example, this may include service time counters. However, the aspects of this disclosure are not limited to these examples and the memory 450 can include other thresholds, timers, and/or counters.

System 400 can also include the communication infrastructure 440. The communication infrastructure 440 provides communication between, for example, the processor 410, the one or more transceivers 420, and the memory 450. In some implementations, the communication infrastructure 440 may be a bus. The processor 410 together with instructions stored in memory 450 performs operations enabling system 400 to implement the continuous service operations and communications with NTN satellites and/or cells, as described herein.

The one or more transceivers 420 transmit and receive communications signals that support the operations of system 400 including, but not limited to, NTN and/or TN communications, according to some aspects, and may be coupled to the antenna 430. The antenna 430 may include one or more antennas that may be the same or different types. The one or more transceivers 420 allow system 400 to communicate with other devices that may be wired and/or wireless. In some examples, the one or more transceivers 420 can include processors, controllers, radios, sockets, plugs, buffers, and like circuits/devices used for connecting to and communication on networks. According to some examples, the one or more transceivers 420 include one or more circuits to connect to and communicate on wired and/or wireless networks.

According to some aspects, the one or more transceivers 420 can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 420 can include more or fewer systems for communicating with other devices.

In some examples, the one or more transceivers 420 can include one or more circuits (including a WLAN transceiver) to enable connection(s) and communication over WLAN networks such as, but not limited to, networks based on standards described in IEEE 802.11. Additionally, or alternatively, the one or more transceivers 420 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 420 can include a Bluetooth™ transceiver.

Additionally, the one or more transceivers 420 can include one or more circuits (including a cellular transceiver) for connecting to and communicating on cellular networks and satellite networks, including an NTN network. The cellular networks can include, but are not limited to, 3G/4G/5G networks such as Universal Mobile Telecommunications System (UMTS), Long-Term Evolution (LTE), and the like. For example, the one or more transceivers 420 can be configured to operate according to one or more of Rel-15, Rel-16, Rel-17, or other of the 3GPP standards.

According to some aspects, the processor 410, alone or in combination with computer instructions stored within the memory 450, and/or the one or more transceiver 420, implements the processes for providing continuous service for NTN and/or TN communications, as discussed herein.

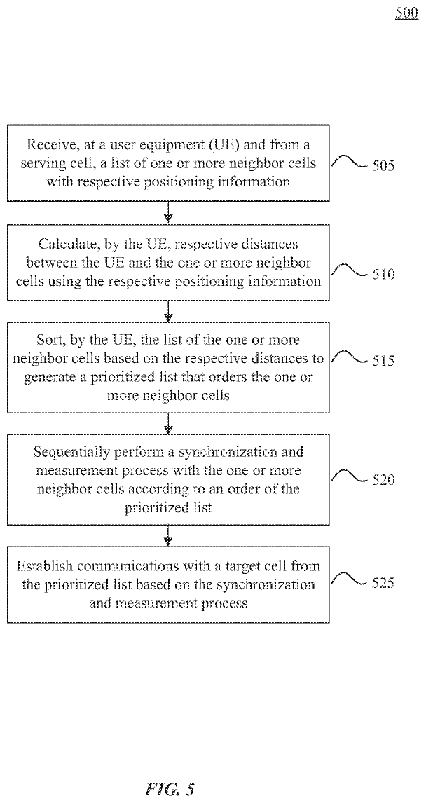

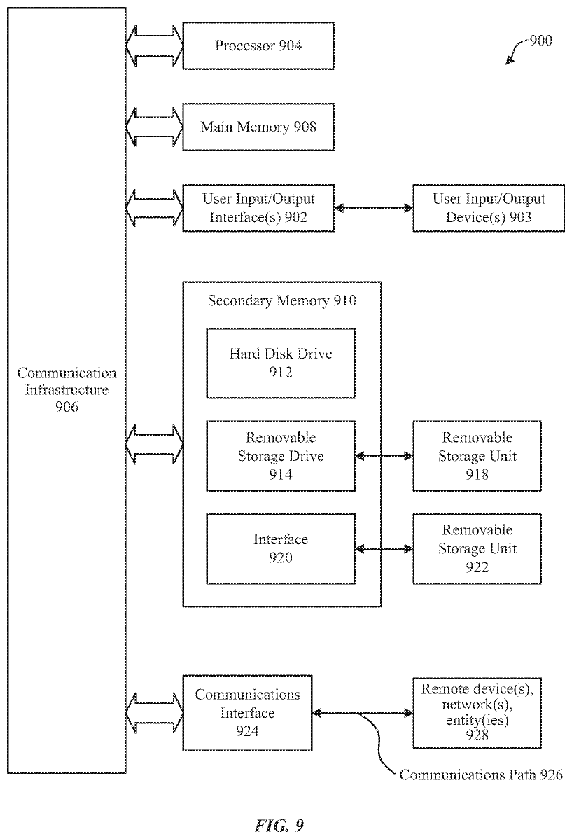

FIG. 5 illustrates an example method for a system (for example, a UE) for establishing communications with a target cell, according to some aspects of the disclosure. As a convenience and not a limitation, FIG. 5 may be described with regard to elements of FIG. 1. Method 500 may represent the operation of a UE (for example, UE 110, 210, or 310 of FIG. 1, FIG. 2, or FIG. 3) implementing operations for providing continuous connectivity to a mobile network. Method 500 may also be performed by system 400 of FIG. 4 and/or computer system 900 of FIG. 9. But method 500 is not limited to the specific aspects depicted in those figures and other systems may be used to perform the method as will be understood by those skilled in the art. It is to be appreciated that not all operations may be needed, and the operations may not be performed in the same order as shown in FIG. 5.

At 505, a UE 110 receives, from a serving cell, a list of one or more neighbor cells with respective positioning information. The serving cell may refer to, for example, a particular satellite and/or the serving area corresponding the satellite. For example, a cell or serving cell may refer to a particular satellite 120 and/or its corresponding cell 130. The list of one or more neighbor cells may identify one or more other satellites 120 and/or base stations and their corresponding service cells. The other satellites 120 and/or base stations may provide cellular service in proximity to the serving cell. In some aspects, a wireless network and/or a NTN identifies the one or more neighbor cells included on the list. This list may be provided in a data packet and/or as control information transmitted from the serving cell to the UE 110. The list may include neighbor cell identification information and/or identifiers that may identify the one or more neighbor cells.

In some aspects, the list identifies a cell type as well. For example, the list may identify a neighbor cell as being a satellite type, an NTN type, a TN type, and/or other type or category information. The cell type information may also indicate whether a satellite is a GSO or non-GSO satellite. The cell-type may also indicate whether the satellite has a fixed earth cell or a moving earth cell. In some aspects, the list may include one or more frequencies and/or carriers used by cell for facilitating communications.

The serving cell may also provide positioning information for each of the one or more neighbor cells as well. This positioning information may include ephemeris information. For example, the ephemeris information may include position, velocity, and/or timing information for each of the one or more neighbor cells. A particular neighbor cell may be a satellite 120 and/or its corresponding cell 130. The satellite, however, may be a non-GSO satellite and/or an earth moving cell. In this case, because the neighbor satellite cell may be moving, the serving cell may inform the UE 110 of the corresponding position, velocity, and/or timing information so that the UE 110 may determine and/or predict a location for the neighbor satellite. The distance calculation is further described with reference to the calculation in 510.

In some aspects, when a neighbor cell is a fixed cell, the positioning information may indicate the position of the cell. For example, for a GSO satellite and/or a terrestrial base station, the list may indicate the particular position of the cell. This may include a coordinate or other location information. In some aspects, the positioning information may not include a velocity and/or timing for non-moving cells.

At 510, UE 110 calculates respective distances between the UE 110 and the one or more neighbor cells using the respective positioning information. For GSO satellites and/or base stations, UE 110 may calculate the distance between UE 110 and the respective cell using the position information provided by the serving cell. In some aspects, this distance calculation may correspond to a distance between the UE 110 and the center of a neighbor cell and/or the distance to an edge of the neighbor cell. For example, the position information provided by the serving cell may include coordinates indicating a position of a cell, satellite, and/or base station. In some aspects, this may include coverage area information.

For non-GSO and/or earth moving satellites, UE 110 may use ephemeris information to calculate the respective distances. The UE 110 may use the position information and/or the velocity and timing information to calculate the respective distance between the UE and the non-GSO and/or earth moving satellites. Velocity information may include a magnitude of speed and/or direction of travel for the neighbor cell. This may be a vector value indicating the velocity for an earth moving satellite. The timing information may indicate a time and/or timestamp corresponding to the velocity information and/or position information. In some aspects, the timing information indicates a current time, a future time, and/or a past time of the information for the neighbor cell. The correlation of the position and/or velocity information with the timing information may allow the UE 110 to calculate the respective distances.

For example, the time may be a current time and/or may indicate a corresponding current position of a satellite providing a neighbor cell. The UE 110 uses this information to calculate a distance between the UE 110 and the neighbor cell. Because the satellite may move according to the velocity information, however, the position of the neighbor cell may be different at a different time. In this manner, the timing information along with the velocity information may be used by the UE 110 to calculate a later and/or future position of the neighbor cell. This calculation may account for a timing when the serving cell will not be serving the UE 110 and/or when there may be a discontinuity in service. UE 110 may determine its own relative position with reference to this future position to determine a target cell for providing service as discussed further below. UE 110 may perform this calculation for each neighbor cell identified on the list of neighbor cells.

In some aspects, the timing information may be a time in the past and/or may correspond to a previous position of the neighbor cell. UE 110 may use this information along with the velocity information to calculate a predicted position and/or a distance between UE 110 and the neighbor cell as well. In some aspects, the timing information may be a time in the future with a corresponding position and/or velocity of a neighbor cell in the future. UE 110 may similarly calculate a distance using this information in a similar manner.

In view of the timing information corresponding to the position and/or velocity information, the UE 110 may determine a current and/or future position for neighbor cell. UE 110 may then determine the distance between itself and the neighbor cell. This determination may be performed when the UE 110 has determined that service with the serving cell will cease. UE 110 may determine the respective distances for each of the neighbor cells in the list provided by the serving cell.

At 515, UE 110 sorts the list of the one or more neighbor cells based on the respective distances to generate a prioritized list that orders the one or more neighbor cells in terms of prioritization. For example, after determining the respective distances, UE 110 ranks the one or more neighbor cells based on the respective distances. UE 110 may prioritize neighbor cells with a closer distance over those having a relatively longer distance. For example, the neighbor cells that are closer to the UE 110 may be prioritized with a higher priority. This prioritization may rank the neighbor cells from a lowest distance to a highest distance.

At 520, UE 110 sequentially performs a synchronization and measurement process with the one or more neighbor cells according to an order of the prioritized list. In some aspects, the UE 110 may perform the synchronization and measurement with each of the one or more neighbor cells based on the order. In some aspects, UE 110 may perform the synchronization and measurement with a subset of the one or more neighbor cells in the prioritized list. The subset may be a predefined number of neighbor cells. For example, UE 110 may be programmed or configured to perform the synchronization and measurement with the top five or closest (in terms of distance) five neighbor cells in the prioritized list. UE 110 may be configured with this threshold (e.g., top five) based on a specification and/or based on a network command or configuration. In some aspects, UE 110 may perform the synchronization and measurement process for each of the cells in the prioritized list. UE 110 may perform the synchronization and measurement process to determine the particular target neighbor cell to use for communications as further described with reference to 525.

The synchronization and measurement process may be used to determine the quality of signals and/or communications between UE 110 and candidate neighbor cells. For example, the synchronization and measurement process may include a cell detection process. This may include cell timing acquisition and/or downlink synchronization with a target cell. For example, UE 110 may acquire timing and of the target cell for signal synchronization.

With this cell detection and cell timing acquisition, UE 110 may perform signal measurements to determine the particular neighbor cell for continued service. In some aspects, UE 110 may perform one or more power measurements to determine signal strength. For example, UE 110 may measure reference signals from the neighbor cells to perform one or more measurements. These measurements may include Reference Signal Received Power (RSRP), Reference Signal Received Quality (RSRQ), Signal to Interference & Noise Ratio (SINR), and/or other signal strength measurements. The RSRP may correspond to an average power of a received pilot signal or reference signal. The RSRQ may characterize the quality of the received pilot signal or reference signal. The SINR may be a ratio of the signal level to the noise level and/or may reflect the signal quality. UE 110 may perform one or more of these measurements for each neighbor cell. For example, UE 110 may perform one or more of these measurements for a subset of the one or more neighbor cells from the list. In some aspects, UE 110 may perform one or more of these measurements for each neighbor cell on the list.

At 525, UE 110 establishes communications with a target cell from the prioritized list based on the synchronization and measurement process. In some aspects, the target cell may be selected from a subset of the one or more neighbor cells if the UE was configured to perform the synchronization and measurement for a subset of the cells. Based on the signal strength measurements, UE 110 may identify a particular target from the list to continue communications. For example, UE 110 may perform a weighting and/or scoring of the measurements to identify the particular target cell. UE 110 may select the target cell having the strongest measured signal and/or the signal with the highest quality. By establishing the communications with the target cell, UE 110 may avoid a potential discontinuity of service when the serving cell no long serves UE 110. In some aspects, the target cell may be a non-GSO satellite, a GSO satellite, or a base station.

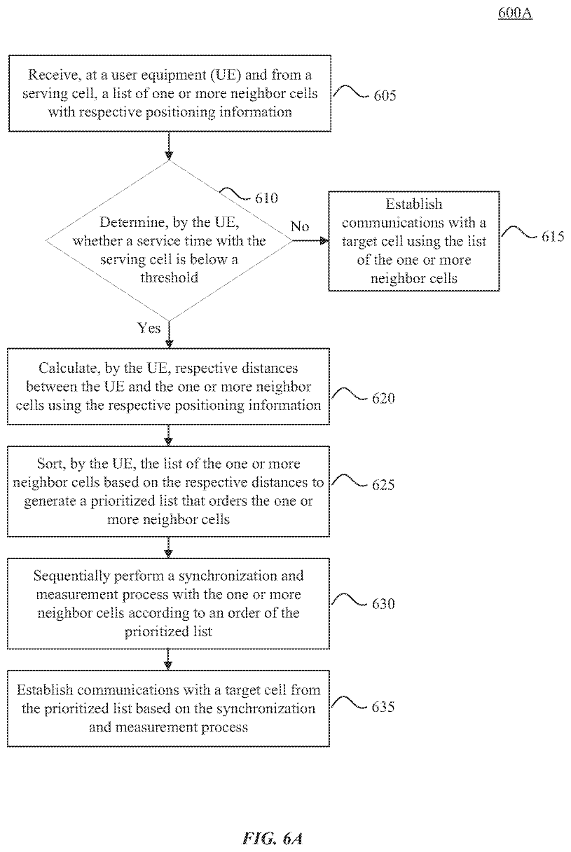

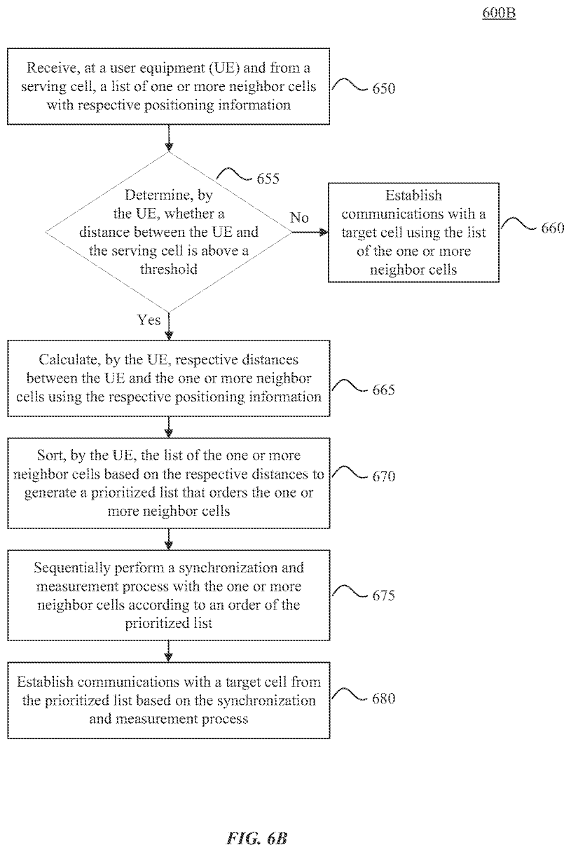

If UE 110 establishes communications with a non-GSO satellite as the target cell, the non-GSO satellite may move again in the future. In this case, that non-GSO satellite may provide another list of neighbor cells to UE 110. UE 110 may then perform method 500 with this new list of neighbor cells to identify another cell to avoid potential discontinuities. For example, a second serving cell may provide a second list with a set of neighbor cells corresponding to the second serving cell. In some aspects, the previous target cell may be the second serving cell. Using the second list, the UE may then establish communications with a subsequent target cell from the set of neighbor cells in the second list in a similar manner. This process with additional lists and additional target cells further applies to the processes described below with reference to FIGS. 6A, 6B, 7, and 8 as well.

FIG. 6A illustrates an example method for a system (for example, a UE) for establishing communications with a target cell based on a service time of a serving cell, according to some aspects of the disclosure. As a convenience and not a limitation, FIG. 6A may be described with regard to elements of FIG. 1. Method 600A may represent the operation of a UE (for example, UE 110, 210, or 310 of FIG. 1, FIG. 2, or FIG. 3) implementing operations for providing continuous connectivity to a mobile network. Method 600A may also be performed by system 400 of FIG. 4 and/or computer system 900 of FIG. 9. But method 600A is not limited to the specific aspects depicted in those figures and other systems may be used to perform the method as will be understood by those skilled in the art. It is to be appreciated that not all operations may be needed, and the operations may not be performed in the same order as shown in FIG. 6A.

At 605, a UE 110 receives, from a serving cell, a list of one or more neighbor cells with respective positioning information. This may be similar to 505 as described with reference to FIG. 5.

At 610, UE 110 determines whether a service time with the serving cell is below a threshold. This determination may be a precondition for determining a target cell from the list of neighbor cells. For example, when the serving time that a serving cell is still above the threshold, UE 110 may still rely on communications and service with the serving cell. UE 110 may use the remaining serving time and the threshold to determine whether to initiate a transfer of service.

For example, the serving cell may be an earth moving satellite, a non-GSO cell, and/or an LEO cell. The serving cell may inform UE 110 of a serving time that the serving cell will maintain a connection with the UE 110. For example, this designation may be for five minutes, two hours, eight hours, or some other time interval. Based on this information, UE 110 may set a timer to identify an amount of time that the UE 110 may connect to the serving cell prior to a potential discontinuity of service, where the timer counts down from an initial value toward the threshold. For example, if the designated service time is two hours, the threshold may be set and/or triggered when there are ten minutes of service time remaining. When the timer reaches the threshold, UE 110 triggers a process for identifying a target neighbor cell for transferring service. The threshold may be configured on UE 110 and/or may be provided via a command by the serving cell. UE 110 may check whether a tracked amount of remaining service time is below a threshold.

If the serving time is not below the threshold, UE 110 proceeds to 615. At 615, UE 110 establishes communications with a target cell using the list of the one or more neighbor cells. For example, the UE 110 may use the list and the order as provided by the serving cell for determining a target cell. UE 110 may not perform sorting or prioritization of the list. The UE 110 may perform a synchronization and measurement process with each of the neighbor cells or a subset of the neighbor cells in the list to identify a target cell. This may occur in a manner similar to 520 and 525 as described with reference to FIG. 5

In some aspects, the list as provided by the serving cell may not be ordered based on distance. The list may be ordered based on a network load balancing. For example, neighbor cells near the beginning of the list may have a lower load than neighbor cells near the end of the list. This configuration may provide a recommendation for the UE 110 to use a neighbor cell near the top of the list of load balancing purposes. UE 110 may use this ordering when a serving time is still above a threshold. This may occur when there is not a time limit or rush scenario requiring UE 110 to quickly identify a target cell. If the serving time is below the threshold, however, the UE 110 may be configured to quickly identify the target cell. Load balancing may be secondary to ensuring that there is no discontinuity in service. When the serving time is below the threshold, UE 110 may sort the list according to distance and identify the target cell based on a closer distance. At 610, if the serving time is below the threshold, UE 110 may proceed to 620.

At 620, UE 110 calculates respective distances between the UE 110 and the one or more neighbor cells using the respective positioning information. This may occur in a manner similar to 510 as described with reference to FIG. 5. At 625, UE 110 sorts the list of the one or more neighbor cells based on the respective distances to generate a prioritized list that orders the one or more neighbor cells, where the closest cells rank higher in the prioritized list. This may occur in a manner similar to 515 as described with reference to FIG. 5. At 630, UE 110 sequentially performs a synchronization and measurement process with the one or more neighbor cells according to an order of the prioritized list. This may occur in a manner similar to 520 as described with reference to FIG. 5. At 635, UE 110 establishes communications with a target cell from the prioritized list based on the synchronization and measurement process. This may occur in a manner similar to 525 as described with reference to FIG. 5.

FIG. 6B illustrates an example method for a system (for example, a UE) for establishing communications with a target cell based on a distance between the UE and a serving cell, according to some aspects of the disclosure. As a convenience and not a limitation, FIG. 6B may be described with regard to elements of FIG. 1. Method 600B may represent the operation of a UE (for example, UE 110, 210, or 310 of FIG. 1, FIG. 2, or FIG. 3) implementing operations for providing continuous connectivity to a mobile network. Method 600B may also be performed by system 400 of FIG. 4 and/or computer system 900 of FIG. 9. But method 600B is not limited to the specific aspects depicted in those figures and other systems may be used to perform the method as will be understood by those skilled in the art. It is to be appreciated that not all operations may be needed, and the operations may not be performed in the same order as shown in FIG. 6B.

At 650, a UE 110 receives, from a serving cell, a list of one or more neighbor cells with respective positioning information. This may be similar to 505 as described with reference to FIG. 5.

At 655, UE 110 determines whether a distance between the UE 110 and the serving cell is above a threshold. This determination may be a precondition for determining a target cell from the list of neighbor cells. For example, when the distance between the UE 110 and the serving cell is still below the threshold, UE 110 may still rely on communications and service with the serving cell. UE 110 may still be in a close proximity and/or be located within a service area of the serving cell based on the determined distance. When the determined distance exceeds a threshold, however, UE 110 may initiate a transfer of service to a target cell. This may occur because the serving cell will likely become too far away for continuous or reliable service.

For example, the serving cell may be an earth moving satellite, a non-GSO cell, and/or an LEO cell. As the serving cell moves, its coverage area may also move. This may result in an increasing distance between the serving cell and the UE 110. When a threshold distance is met or exceeded, a loss of service may be imminent. In some aspects, this threshold distance may still be within a service area so that continuous service is still maintained while transferring to a target cell. Based on the distance measurement and the threshold, UE 110 may begin a process of identifying a target neighbor cell for transferring service. The threshold distance may be configured on UE 110 and/or may be provided via a command by the serving cell. UE 110 may check whether a tracked distance is above a threshold.

If the distance is not above the threshold, UE 110 proceeds to 660. At 660, UE 110 establishes communications with a target cell using the list of the one or more neighbor cells. For example, the UE 110 uses the list and the order as provided by the serving cell for determining a target cell. UE 110 may not perform sorting or prioritization of the list. The UE 110 may perform a synchronization and measurement process with each of the neighbor cells or a subset of the neighbor cells in the list to identify a target cell. This may occur in a manner similar to 520 and 525 as described with reference to FIG. 5.

In some aspects, the list as provided by the serving cell may not be ordered based on distance. The list may be ordered based on a network load balancing. For example, neighbor cells near the beginning of the list may have a lower load than neighbor cells near the end of the list. This configuration may provide a recommendation for the UE 110 to use a neighbor cell near the top of the list of load balancing purposes. UE 110 may use this ordering when a distance between UE 110 and the serving cell is still below a threshold. This may occur when the UE 110 and the serving cell are still in close proximity or when there is no rush scenario requiring UE 110 to quickly identify a target cell. If the distance between UE 110 and the serving cell is above the threshold, however, the UE 110 may be configured to quickly identify the target cell. This may occur when the serving cell is moving away from UE 110. Load balancing may be secondary to ensuring that there is no discontinuity in service. When the distance exceeds the threshold, UE 110 may sort the list according to distance and identify the target cell based on a closer distance. At 655, if the distance is above the threshold, UE 110 proceeds to 665.

At 665, UE 110 calculates respective distances between the UE 110 and the one or more neighbor cells using the respective positioning information. This may occur in a manner similar to 510 as described with reference to FIG. 5. At 670, UE 110 sorts the list of the one or more neighbor cells based on the respective distances to generate a prioritized list that orders the one or more neighbor cells, where the closest cells rank higher in the prioritized list. This may occur in a manner similar to 515 as described with reference to FIG. 5. At 675, UE 110 sequentially performs a synchronization and measurement process with the one or more neighbor cells according to an order of the prioritized list. This may occur in a manner similar to 520 as described with reference to FIG. 5. At 680, UE 110 establishes communications with a target cell from the prioritized list based on the synchronization and measurement process. This may occur in a manner similar to 525 as described with reference to FIG. 5.

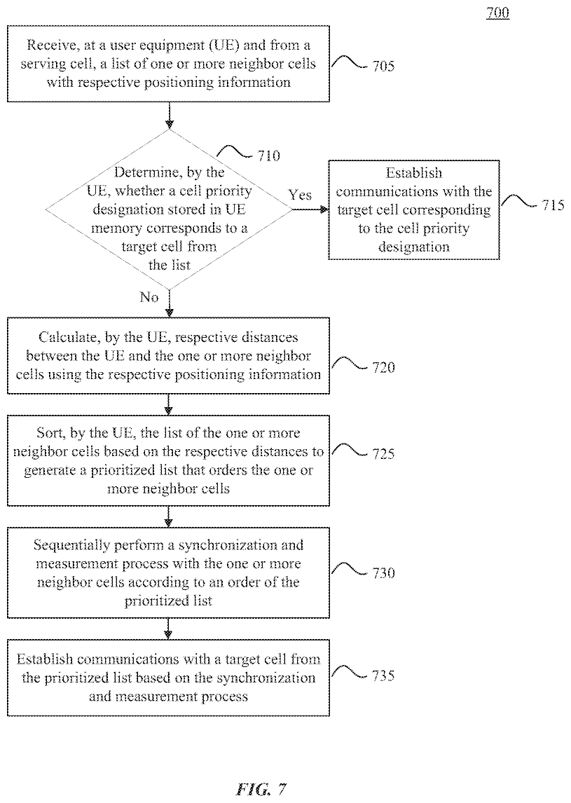

FIG. 7 illustrates an example method for a system (for example, a UE) for establishing communications with a target cell based on a cell priority designation, according to some aspects of the disclosure. As a convenience and not a limitation, FIG. 7 may be described with regard to elements of FIG. 1. Method 700 may represent the operation of a UE (for example, UE 110, 210, or 310 of FIG. 1, FIG. 2, or FIG. 3) implementing operations for providing continuous connectivity to a mobile network. Method 700 may also be performed by system 400 of FIG. 4 and/or computer system 900 of FIG. 9. But method 700 is not limited to the specific aspects depicted in those figures and other systems may be used to perform the method as will be understood by those skilled in the art. It is to be appreciated that not all operations may be needed, and the operations may not be performed in the same order as shown in FIG. 7.

At 705, a UE 110 receives, from a serving cell, a list of one or more neighbor cells with respective positioning information. This may be similar to 505 as described with reference to FIG. 5.

At 710, UE 110 determines whether a cell priority designation stored in UE 110 memory corresponds to a target cell from the list. For example, UE 110 may be configured to prioritize a particular type of cell as a target cell. If UE 110 identifies a target cell matching that type prioritization, UE 110 may establish communications with that target cell. For example, UE 110 may prioritize a GSO cell, a TN cell, base station, gNB, and/or a non-GSO cell with a fixed earth cell. This prioritization may reflect stable, stationary, and/or slow moving cells which may provide continuous coverage. In some aspects, UE 110 may prioritize one or more of these types of cells over non-GSO moving earth cells.

In some aspects, the cell priority designation may also be based on a carriers. For example, UE 110 may prioritize carriers which carry signals from a GSO cell, TN cell, and/or non-GSO with a fixed earth cell. For example, on a particular frequency carrier or set of frequency carriers, a UE 110 may experience a discontinuity with the serving cell and other neighbor cells. On a different frequency carrier, however, there may be other satellites which provide coverage for a cell area covering UE 110. In this manner, the cell priority designation may specify a cell type and/or frequency carrier for prioritization. In some aspects, this configuration may also specify a priority order for the cell type and/or carrier to use. In some aspects, UE 110 may be pre-configured with this prioritization. In some aspects, the serving cell may provide a command to UE 110 instructing UE 110 of the priority.

If a cell priority has been designated, UE 110 proceeds to 715. The determination at 710 may determine whether a cell type priority and/or a carrier priority has been designated. In some aspects, the determination at 710 determines whether any cell priority designation matches one or more neighbor cells from the list received from the serving cell. If so, UE 110 proceeds to 715. At 715, UE 110 establishes communications with the target cell corresponding to the cell priority designation. For example, if UE 110 is configured to prioritize a GSO cell and a GSO cell is on the list of neighbor cells, UE 110 may establish communications with that GSO cell. Similarly, if the priority designation prioritizes a GSO cell using a particular frequency carrier, UE 110 may establish communications with that GSO cell using the specified frequency carrier. In some aspects, this may occur in a manner similar to 525 as described with reference to FIG. 5. UE 110 may perform a synchronization and measurement process with the neighbor cell to establish communications. If a cell priority has not been designated and/or if there is no cell from the list matching a designated cell priority, UE 110 proceeds to 720.

At 720, UE 110 calculates respective distances between the UE 110 and the one or more neighbor cells using the respective positioning information. This may occur in a manner similar to 510 as described with reference to FIG. 5. At 725, UE 110 sorts the list of the one or more neighbor cells based on the respective distances to generate a prioritized list that orders the one or more neighbor cells, where the closest cells rank higher in the prioritized list. This may occur in a manner similar to 515 as described with reference to FIG. 5. At 730, UE 110 sequentially performs a synchronization and measurement process with the one or more neighbor cells according to an order of the prioritized list. This may occur in a manner similar to 520 as described with reference to FIG. 5. At 735, UE 110 establishes communications with a target cell from the prioritized list based on the synchronization and measurement process. This may occur in a manner similar to 525 as described with reference to FIG. 5.

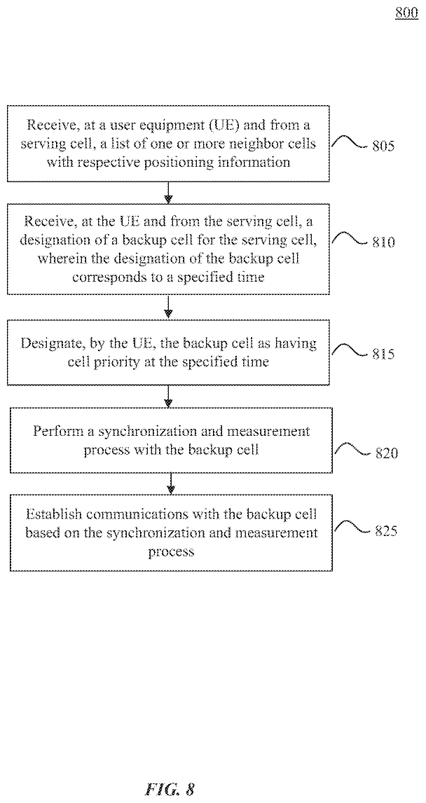

FIG. 8 illustrates an example method for a system (for example, a UE) for establishing communications with a target cell based on a backup cell designation, according to some aspects of the disclosure. As a convenience and not a limitation, FIG. 8 may be described with regard to elements of FIG. 1. Method 800 may represent the operation of a UE (for example, UE 110, 210, or 310 of FIG. 1, FIG. 2, or FIG. 3) implementing operations for providing continuous connectivity to a mobile network. Method 800 may also be performed by system 400 of FIG. 4 and/or computer system 900 of FIG. 9. But method 800 is not limited to the specific aspects depicted in those figures and other systems may be used to perform the method as will be understood by those skilled in the art. It is to be appreciated that not all operations may be needed, and the operations may not be performed in the same order as shown in FIG. 8.

At 805, a UE 110 receives, from a serving cell, a list of one or more neighbor cells with respective positioning information. This may be similar to 505 as described with reference to FIG. 5. The serving cell may correspond to a non-geostationary orbiting (non-GSO) satellite with an earth moving cell, a GSO satellite, or a non-GSO satellite with a fixed earth cell.

At 810, UE 110 receives, from the serving cell, a designation of a backup cell for the serving cell. The backup cell may correspond to a geostationary orbiting (GSO) satellite or a terrestrial network (TN) base station. The designation of the backup cell may corresponding to a specified time. For example, the serving cell may inform UE 110 of a particular backup cell and/or provide a backup cell identification. For example, a network may not be aware of a particular UE 110 location but may be aware of the deployment of its satellites. The network may be aware of satellite locations and/or satellite coverage areas. Based on the awareness of coverage areas, the network may designate a backup cell for the UEs of a particular serving cell. Due to the potential movement of the serving cell and/or backup cell, the backup cell designation may correspond to a specific timing. As the timing changes, the designated backup cell may also change. UE 110 may prioritize the backup cell over the one or more neighbor cells from the list provided by the serving cell.

FIG. 2 may be used to illustrate an example backup cell configuration. For example, satellite 240 may be designated as a backup cell for satellites 220A and/or 220B. For example, satellite 240 may be a GSO satellite while satellites 220A, 220B may be non-GSO satellites. The network and/or a particular UE's serving cell may inform the UE that satellite 240 has been designated as the backup cell. For example, if a UE is communicating with satellite 220A, satellite 220A may inform that UE and/or other UEs serviced by satellite 220A that satellite 240 has been designated as a backup cell. Satellite 220B may transmit the identity of the backup cell to the UEs serviced by satellite 220B as well. In some aspects, the serving cells also identify frequency carriers to use for communication with a backup cell. When designating the backup cell and/or frequency carriers, the serving cells may designate a timing for the UE to use satellite 240 as a backup cell and/or to use the specified frequency carriers. When a UE is within the coverage area of the serving cell and within the specified timing, the UE may prioritize the identified backup cell over other potential neighbor cells for a connection. For example, a UE within cell 230A corresponding to 220A may also monitor satellite 240 as well for use as the backup cell if communications with satellite 220A are interrupted. While FIG. 2 depicts satellite 240, in some aspects, multiple backup cells may be specified by the network. The UE may receive this backup cell designation and/or a corresponding time period.

At 815, UE 110 designates the backup cell as having cell priority at the specified time. For example, UE 110 may store a backup cell identifier and/or a time designation in memory. In this case, UE 110 may be configured to connect to the backup cell if communications with the serving cell are interrupted or cease. This connection may be based on whether the specified timing condition is met. In some aspects, the designated backup cell may be replacing a previous backup cell designation. This may occur if the previous designation has expired or is no longer specified as the backup cell based on the network's determination.

At 820, UE 110 performs a synchronization and measurement process with the backup cell. This may occur when there is an interruption in service with the serving cell and/or when there is a discontinuity. This may also occur at the specified time. The synchronization and measurement process may be similar to 520 as described with reference to FIG. 5. At 825, UE 110 may establish communications with the backup cell based on the synchronization and measurement process. This may also occur at the specified time and/or may be similar to 525 as described with reference to FIG. 5.

Various aspects can be implemented, for example, using one or more computer systems, such as computer system 900 shown in FIG. 9. Computer system 900 can be any well-known computer capable of performing the functions described herein such as devices 110, 120, 210, 220, 310, 320, 350, 400 of FIGS. 1-4 respectively. Computer system 900 includes one or more processors (also called central processing units, or CPUs), such as a processor 904. Processor 904 is connected to a communication infrastructure 906 (e.g., a bus). Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communications; and
a processor communicatively coupled to the transceiver and configured to:
receive, from a serving cell, a list of one or more neighbor cells with respective positioning information;
calculate respective distances between the UE and the one or more neighbor cells using the respective positioning information;
sort the list of the one or more neighbor cells based on the respective distances to generate a prioritized list that orders the one or more neighbor cells based on the respective distances;
sequentially perform a synchronization and measurement process with the one or more neighbor cells according to an order of the prioritized list; and
establish communications with a target cell from the prioritized list based on the synchronization and measurement process.

2. The UE of claim 1, wherein the respective positioning information includes position, velocity, or timing information.

3. The UE of claim 1, wherein to sequentially perform the synchronization and measurement process, the processor is further configured to:
identify a subset of the one or more neighbor cells based on the order of the prioritized list and a predefined number of neighbor cells; and
perform the synchronization and measurement process for each neighbor cell in the subset.

4. The UE of claim 1, wherein to sequentially perform the synchronization and measurement process, the processor is further configured to:
perform Reference Signal Received Power (RSRP), Reference Signal Received Quality (RSRQ), or Signal to Interference & Noise Ratio (SINR) measurements.

5. The UE of claim 1, wherein the processor is further configured to calculate the respective distances in response to determining that a serving time corresponding to the serving cell is below a threshold.

6. The UE of claim 1, wherein the processor is further configured to:
receive a second list from a second serving cell, wherein the second list includes a set of neighbor cells for the second serving cell;
determine that a service time corresponding to the second serving cell is above a threshold;
sequentially perform a second synchronization and measurement process with the set of neighbor cells according to an order of the second list; and
establish communications with a cell from the set of neighbor cells based on the second synchronization and measurement process.

7. The UE of claim 1, wherein the processor is further configured to calculate the respective distances in response to a determining that a distance between the UE and the serving cell is above a threshold.

8. The UE of claim 1, wherein the processor is further configured to:
receive a second list from a second serving cell, wherein the second list includes a set of neighbor cells for the second serving cell;
determine that a distance between the UE and the second serving cell is below a threshold;
sequentially perform a second synchronization and measurement process with the set of neighbor cells according to an order of the second list; and
establish communications with a cell from the set of neighbor cells based on the second synchronization and measurement process.

9. The UE of claim 1, wherein the processor is further configured with a cell type priority designation and wherein the processor is further configured to calculate the respective distances in response to determining that the one or more neighbor cells do not match the cell type priority designation.

10. The UE of claim 1, wherein the processor is further configured with a cell type priority designation and wherein the processor is further configured:
receive a second list from a second serving cell, wherein the second list includes a set of neighbor cells for the second serving cell;
determine that a neighbor cell from the set matches the cell type priority designation;
perform a second synchronization and measurement process with the neighbor cell; and
establish communications with the neighbor cell having the matching cell type priority designation.

11. The UE of claim 10, wherein the cell type priority designation identifies a geostationary orbiting (GSO) satellite, a terrestrial network (TN) cell, or a non-GSO satellite with a fixed earth cell.

12. An apparatus, comprising:
a memory; and
at least one processor coupled to the memory and configured to:
receive, from a serving cell, a designation of a backup cell for the serving cell, wherein the designation of the backup cell corresponds to a specified time;
designate the backup cell as having a cell priority at the specified time;
perform a synchronization and measurement process with the backup cell at the specified time; and
establish communications with the backup cell based on the synchronization and measurement process at the specified time.

13. The apparatus of claim 12, wherein to designate the backup cell as having the cell priority, the at least one processor is further configured to:
designate the backup cell as having a higher priority than a list of one or more neighbor cells received from the serving cell.

14. The apparatus of claim 12, wherein the backup cell corresponds to a geostationary orbiting (GSO) satellite or a terrestrial network (TN) base station.

15. The apparatus of claim 12, wherein the serving cell corresponds to a non-geostationary orbiting (non-GSO) satellite with an earth moving cell, a GSO satellite, or a non-GSO satellite with a fixed earth cell.

16. A method, comprising:
receiving, at a user equipment (UE) and from a serving cell, a list of one or more neighbor cells with respective positioning information;
calculating, by the UE, respective distances between the UE and the one or more neighbor cells using the respective positioning information;
sorting, by the UE, the list of the one or more neighbor cells based on the respective distances to generate a prioritized list that orders the one or more neighbor cells based on the respective distances;
sequentially performing, by the UE, a synchronization and measurement process with the one or more neighbor cells according to an order of the prioritized list; and
establishing, by the UE, communications with a target cell from the prioritized list based on the synchronization and measurement process.

17. The method of claim 16, wherein the respective positioning information includes position, velocity, or timing information.

18. The method claim 16, wherein to sequentially perform the synchronization and measurement process, the method further comprises:
identifying a subset of the one or more neighbor cells based on the order of the prioritized list and a predefined number of neighbor cells; and
performing the synchronization and measurement process for each neighbor cell in the subset.

19. The method of claim 16, wherein to sequentially perform the synchronization and measurement process, the method further comprises:
performing Reference Signal Received Power (RSRP), Reference Signal Received Quality (RSRQ), or Signal to Interference & Noise Ratio (SINR) measurements.

20. The method of claim 16, wherein calculating the respective distances occurs in response to determining that a serving time corresponding to the serving cell is below a threshold.
